(19) United States
(12) Patent Application Publication
(10) Pub. No.: US 2023/0413112 A1
(43) Pub. Date: Dec. 21, 2023

(54) MANAGING ASSOCIATION OF A CLIENT DEVICE WITH VIRTUAL ACCESS POINTS

(71) Applicant: Hewlett Packard Enterprise Development LP, Houston, TX (US)

(72) Inventors: Abhiruchi DAKSHINKAR, San Jose, CA (US); Qiang ZHOU, San Jose, CA (US); Shubham SALONI, San Jose, CA (US)

(21) Appl. No.: 17/807,000

(22) Filed: Jun. 15, 2022

(51) Int. Cl. H04W 28/08; H04W 48/20

(52) U.S. Cl. CPC H04W 28/0804; H04W 28/0967; H04W 48/20

(57) ABSTRACT

Examples described herein relate to a method for managing association of a client device with a virtual access point (VAP) hosted on an access point (AP). The method includes monitoring, by the AP, data traffic corresponding to the client device associated with a first VAP. The first VAP is mapped to a first Multiple Basic Service Set Identifier (MBSSID) set configured with a first quality of service (QoS) parameter. The AP also hosts a second VAP mapped to a second MBSSID set configured with a second QoS parameter. Further, the AP determines a communication demand of the client device based on the data traffic. Furthermore, the AP steers the client device to the second VAP based on the communication demand and the second QoS parameter, and communicates with the client device through the second VAP.

### BACKGROUND

Virtual Access Points (VAPs) may be created in a physical Access Point (AP). Each of these VAPs is configured with a unique Basic Service Set Identifier (BSSID) and appears as an individual AP to client devices. In some implementations, to improve airtime efficiency, support for a Multiple Basic Service Set Identifier (MBSSID) set is suggested in 802.11ax Specification by the Institute of Electrical and Electronics Engineers (IEEE) (hereinafter referred to as IEEE 802.11ax Specification). As per the IEEE 802.11ax Specification, instead of sending individual beacons for each VAP, the AP may send a single beacon for the VAPs that are part of the MBSSID set.

### BRIEF DESCRIPTION OF THE DRAWINGS

One or more examples in the present disclosure are described in detail with reference to the following Figures. The Figures are provided for purposes of illustration only and merely depict examples.

FIG. 1 depicts a system in which various of the examples presented herein may be implemented.

FIG. 2A depicts a configuration corresponding to an example first MBSSID set.

FIG. 2B depicts a configuration corresponding to an example second MBSSID set.

FIG. 3 depicts a flowchart of an example method for managing an association of a client device with an AP.

FIG. 4 depicts a flowchart of another example method for managing an association of a client device with an AP.

FIG. 5 depicts a block diagram of an example computing system in which various of the examples described herein may be implemented.

The Figures are not exhaustive and do not limit the present disclosure to the precise form disclosed.

### DETAILED DESCRIPTION

Today, advances in wireless networking technologies drive technological improvements in other technologies and industries. For example, various industries rely on wireless networking technologies for the communication, storage, and delivery of data and services. In wireless networks, client devices wirelessly connect to a network through an AP. Increasing usage of wireless networking technologies, among other factors, creates various technological challenges in the field of wireless networking. The IEEE has issued various standard Specifications, such as the 802.11 Specifications to address various challenges in the field of wireless networking technologies. For instance, as various technologies increasingly rely on wireless networking technologies, there becomes a need to expand the capabilities of wireless networks to accommodate larger numbers of devices with varying configurations. For example, configuring the VAPs on an AP allows the AP to present itself as multiple APs. To client devices, a VAP appears as a separate AP. A VAP can be configured with respective network properties, such as authentication and encryption, and its set of network properties that can be indicated by a unique BSSID. Thus, each VAP can be associated with a BSSID configured with a set of network properties associated with the VAP.

Typically, an AP announces a wireless network by transmitting a beacon frame. In the case of an AP configured with multiple VAPs, the AP typically broadcasts a beacon frame for each VAP of the multiple VAPs, where the beacon frame includes a BSSID associated with the VAP. The beacon frames are broadcasted to the client devices. The client devices use the BSSID included in the beacon frames to determine a VAP to connect. In some deployments, an AP can support multiple wireless networks using multiple VAPs. For example, in some APs, up to sixteen VAPs may be configured on each radio and the AP may support multiple radios (e.g., 2.4 GHz, 5 GHz, and/or 6 GHz). In these deployments, broadcasting a separate beacon frame for each VAP (i.e., for each BSSID) may be inefficient and degrade the connection quality of the wireless networks.

A technique to address the inefficiencies and network degradation associated with broadcasting separate beacon frames entails implementing an MBSSID set in accordance with IEEE 802.11ax Specification. An MBSSID set is a group of VAPs hosted on an AP for which the AP can make use of common management frames, such as, beacon and probes, for example. A beacon frame corresponding to the MBSSID set is hereinafter referred to as an MBSSID beacon. In the MBSSID beacon, a BSSID field is set to a BSSID of one of the VAPs of the MBSSID set. The VAP whose BSSID is used in the BSSID field in the MBSSID beacon is referred to as a transmitted VAP and its BSSID is referred to as a transmitted BSSID. The rest of the VAPs of the MBSSID set are referred to as non-transmitted VAPs and their BSSIDs are referred to as non-transmitted BSSIDs. Broadcasting the MBSSID beacons allows the AP to use fewer beacon frames than the AP would by broadcasting separate beacon frames individually for each VAP.

While the use of the MBSSID set allows APs to broadcast information associated with a plurality of VAPs forming the MBSSID set with improved airtime efficiency, the use of the MBSSID set faces various technological challenges. For example, advertising all the virtual access points (VAPs) in a single MBSSID beacon may lead to beacon size bloating (i.e., the MBSSID beacon size becoming too large). The IEEE 802.11ax Specification suggests Enhanced Multiple BSSID advertisement (EMA) features to deal with the overflowing beacon contents. However, the EMA features are not mandated by the Wi-Fi Alliance tests and hence not widely deployed. To address this issue, APs may be configured to support the use of multiple MBSSID sets which entails dividing VAPs into multiple groups (sets). The AP then sends a beacon for each of these sets. For example, if the VAPs hosted on the AP are grouped into a plurality of MBSSID sets, instead of sending one large beacon for all of the VAPs hosted on the AP, the AP may send a beacon for each of the plurality of MBSSID sets. In some implementations, each of these MBSSID sets is configured to have VAPs with similar settings such that each MBSSID set addresses a specific QoS parameter (e.g., High Throughput, Low Latency, overlapping target wake time (TWT) periods, etc.). The client devices connected to such VAP may not be able to perform with high efficiency if the communication requirements of the client devices are not fulfilled by the respective VAPs. This results in degraded performance of the client devices and AP causing poor user experience.

In accordance with some examples, a method for managing associations of the client devices with VAPs is presented to enhance the performance of the devices. After a client device has associated with a VAP of any MBSSID set, the AP monitors the data traffic corresponding to the client device and determines a communication demand of the client device based on the data traffic. If there is an MBSSID set that can better cater to the communication demand of the client, the AP is configured to steer the client device to a VAP of such a relevant MBSSID set. For example, if a client device is identified to have high throughput requirements, such client device may be steered to another VAP of another MBSSID set that has VAPs addressing the high throughput QoS. By steering the client devices in this manner, the client device's performance with respect to its communication demand can be improved and both the AP and the client device can benefit from advanced Wi-Fi communication features such as multiple-user (MU) transmissions thereby enhancing overall airtime efficiency.

The following detailed description refers to the accompanying drawings. It is to be expressly understood that the drawings are for the purpose of illustration and description only. While several examples are described in this document, modifications, adaptations, and other implementations are possible. Accordingly, the following detailed description does not limit disclosed examples. Instead, the proper scope of the disclosed examples may be defined by the appended claims.

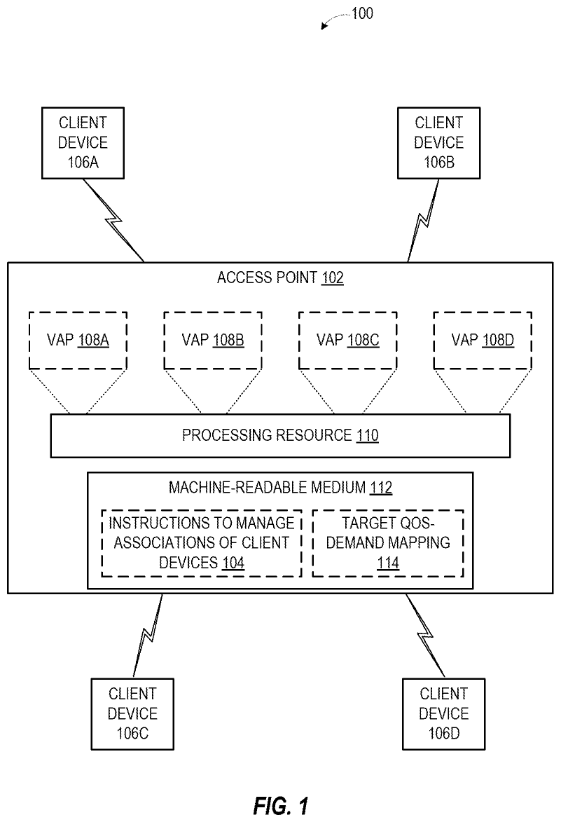

Before describing examples of the disclosed systems and methods in detail, it is useful to describe an example network installation with which these systems and methods might be implemented in various applications. FIG. 1 illustrates a system 100 in which various of the examples presented herein may be implemented. The system 100 may be implemented in any setup for example, in a home setup or an organization, such as a business, educational institution, governmental entity, healthcare facility, or other organization. The system 100 depicts a network of devices (hereinafter referred to as network devices) for example, an AP 102 and a plurality of client devices 106A, 106B, 106C, and 106D (hereinafter referred to as client devices 106A-106D). The system 100 may include a greater or fewer number of APs and the client devices than depicted in FIG. 1.

The client devices 106A-106D may be electronic devices capable of wirelessly communicating with an AP 102 or other electronic devices. Examples of client devices 106A-106D may include desktop computers, laptop computers, servers, web servers, authentication servers, authentication-authorization-accounting (AAA) servers, Domain Name System (DNS) servers, Dynamic Host Configuration Protocol (DHCP) servers, Internet Protocol (IP) servers, Virtual Private Network (VPN) servers, network policy servers, mainframes, tablet computers, e-readers, netbook computers, televisions and similar monitors (e.g., smart TVs), content receivers, set-top boxes, personal digital assistants (PDAs), mobile phones, smartphones, smart terminals, dumb terminals, virtual terminals, video game consoles, virtual assistants, Internet of Things (IoT) devices, and the like. Communications between the AP 102 and the client devices 106A-106D in the system 100 may be facilitated via wireless communication links according to the wireless communication protocols such as 802.11 standards, Wi-Fi Alliance Specifications, or any other wireless communication standards. In some examples, the communication between the client devices 106A-106D and the AP 102 may be carried out in compliance with IEEE 802.11ax Specification.

The AP 102 may be a combination of hardware, software, and/or firmware that is configured to provide wireless network connectivity to the client devices 106A-106D. In some examples, the AP 102 may comprise, be implemented as, or known as a radio router, radio transceiver, a switch, a Wi-Fi hotspot device, Basic Service Set (BSS) device, Extended Service Set (ESS) device, radio base station (RBS), or some other terminology and may act as a point of network access for the client devices 106A-106D. Although not shown, in some examples, the system 100 may include additional network devices such as, but not limited to, additional APs, wireless local area network (WLAN) controllers, network switches, gateway devices, routers, and the like. Via the AP 102, the client devices 106A-106D may communicate with each other and/or with any other network device to which the AP 102 is communicatively connected (e.g., the network switches, the WLAN controller, and/or gateway devices).

In some examples, the AP 102 may include a processing resource 110 and/or a machine-readable storage medium 112 for the AP to execute several operations as will be described in the greater details below. The machine-readable storage medium 112 may be non-transitory and is alternatively referred to as a non-transitory machine-readable storage medium that does not encompass transitory propagating signals. The machine-readable storage medium 112 may be any electronic, magnetic, optical, or other storage device that may store data and/or executable instructions. Examples of the machine-readable storage medium 112 that may be used in the AP 102 may include Random Access Memory (RAM), non-volatile RAM (NVRAM), an Electrically Erasable Programmable Read-Only Memory (EEPROM), a storage drive (e.g., a solid-state drive (SSD) or a hard disk drive (HDD)), a flash memory, and the like. The machine-readable storage medium 112 may be encoded with executable instructions 104 (depicted using dashed box in FIG. 1) for managing the associations of the client devices 106A-106D with the AP 102. Although not shown, in some examples, the machine-readable storage medium 112 may be encoded with certain additional executable instructions to perform any other operations performed by the AP 102, without limiting the scope of the present disclosure.

The processing resource 110 may be a physical device, for example, a central processing unit (CPU), a microprocessor, a graphics processing unit (GPU), a field-programmable gate array (FPGA), application-specific integrated circuit (ASIC), other hardware devices capable of retrieving and executing instructions stored in the machine-readable storage medium 112, or combinations thereof. The processing resource 110 may fetch, decode, and execute the instructions 104 stored in the machine-readable storage medium 112 to manage associations of client devices with one or more VAPs (described later) hosted on the AP 102. As an alternative or in addition to executing the instructions 104, the processing resource 110 may include at least one integrated circuit (IC), control logic, electronic circuits, or combinations thereof that include a number of electronic components for performing the functionalities intended to be performed by the AP 102.

Further, as shown in FIG. 1, the AP 102 may be configured with a set of logical entities such as VAPs 108A, 108B, 108C, and 108D (hereinafter collectively referred to as VAPs 108A-108D) that are depicted using dashed boxes in FIG. 1. In particular, configuration files and program instructions (not shown) to execute the VAPs 108A-108D are stored in the machine-readable storage medium 112. A configuration file for a given VAP may include settings such as radio details, SSID, channel information, a BSSID, communication capabilities, and the like. Each of the VAPs 108A-108D is associated with a unique BSSID configured with a set of network properties associated with the VAP. A BSSID of a given VAP may act as a unique address for the given VAP. In one example, the BSSID may be expressed as a unique string of hexadecimal numbers of predefined length. The processing resource 110 may execute program instructions according to the respective configuration files to enable the functioning of the VAPs 108A-108D.

To the client device 106A-106D, a VAP appears as an independent AP with a wireless network name, commonly referred to as, a service set identifier (SSID). In the example implementation of FIG. 1, the VAPs 108A-108D configured on the AP 102 may appear as four independent APs advertised via respective SSIDs to the client devices 106A-106D. For illustration purposes, the AP 102 is shown as configured with three VAPs 106A-106D. In some examples, the AP 102 may be configured with a greater or fewer number of VAPs than depicted in FIG. 1 without limiting the scope of the present disclosure.

Further, in some examples, the VAPs 108A-108D may be configured to communicate using the same radio of the AP 102. For example, all of the VAPs 108A-108D may communicate with respective client devices via any one of the 2.4 GHz, 5 GHz, or 6 GHz radios. In some examples, while one or more of the VAPs 108A-108D are configured to communicate via one radio, other one or more of the VAPs are configured to communicate via another radio of the AP 102. In one example, the VAPs 108A and 108B are configured to communicate via the 5 GHz and the VAPs 108C and 108D are configured to communicate via the 6 GHz or the 2.4 GHz radios.

The client devices 106A-106D may associate with any of the VAPs 106A-106D as if they are associating with any physical AP. Table 1 presented below depicts an example association of the client devices with respective VAPs.

TABLE 1
Example association of client devices

| Client Device | VAP |
|---|---|
| 106A | 108A |
| 106B | 108B |
| 106C | 108C |
| 106D | 108D |

In the example association shown in Table-1, the client devices 106A, 106B, 106C, and 106D are associated with the VAPs 108A, 108B, 108C, and 108D, respectively. The example association depicted in Table-1 is hereinafter referred to as an initial or preliminary association. It is to be noted that in some other example implementations, more than one client device may be associated with one VAP and/or certain VAPs may not have any client device associated therewith.

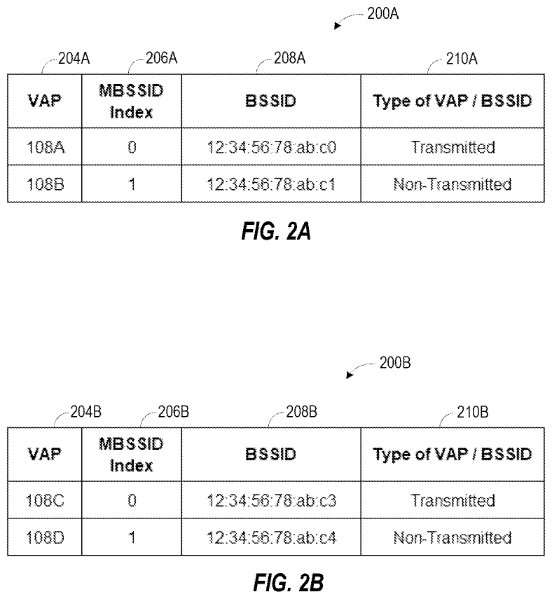

In the present implementation of FIG. 1, the AP 102 implements multiple MBSSID sets and inserts an MBSSID element in several frames that it transmits to enhance airtime efficiency. In particular, the AP 102 combines the BSSIDs of the VAPs 108A-108D into a plurality of MBSSID sets. For illustration purposes hereinafter, the VAPs 108A-108D are considered to be grouped into two MBSSID sets—a first MBSSID set and a second MBSSID set. Example configurations of the first and second MBSSID sets implemented by the AP 102 are shown in FIGS. 2A and 2B, and are described concurrently with FIG. 1.

Turning to FIGS. 2A and 2B, configurations corresponding to an example first MBSSID set and an example second MBSSID set are presented in the form of tables 200A and 200B, respectively. Tables 200A and 200B list VAPs, respective BSSIDs, MBSSID index, associated clients, and VAP/BSSID types in the first MBSSID set and the second MBSSID set, respectively.

For example, in FIG. 2A, a column 204A includes a listing of the VAPs, e.g., VAPs 108A and 108B, that form the first MBSSID set. Further, a column 206A lists the corresponding index numbers (hereinafter referred to as an MBSSID index) of the VAPs 108A and 108B in the first MBSSID set. A column 208A lists example BSSIDs corresponding to the VAPs 108A and 108B. Further, a column 210A depicts the type of each of the VAPs 108A and 108B (or the respective BSSIDs) for the given MBSSID set. As depicted in FIG. 2A, the VAP 108A is configured as a transmitted VAP for the first MBSSID set, meaning the AP 102 uses the BSSID of the VAP 108A in a BSSID field in a media access control (MAC) header of one or more management frames (e.g., a beacon frames). Accordingly, the BSSID of the VAP 108A is referred to as a transmitted BSSID for the first MBSSID set. In some examples, the transmitted BSSID and the MBSSID index may be included in one or more management frames (e.g., beacon frames) transmitted by the AP 102. The client devices 106A and 106B may deduce a non-transmitted BSSID based on the transmitted BSSID using the MBSSID index contained in such management frames.

In FIG. 2B, a column 204B includes a listing of the VAPs, e.g., VAPs 108C and 108D, that form the second MBSSID set. Further, a column 206B lists the MBSSID indexes of the VAPs 108A and 108B in the second MBSSID set. A column 208B lists example BSSIDs corresponding to the VAPs 108C and 108D. Further, a column 210B depicts the type of each of the VAPs 108C and 108D (or the respective BSSIDs) for the given MBSSID set. As depicted in FIG. 2B, the VAP 108C is configured as a transmitted VAP for the first MBSSID set, meaning the AP 102 uses the BSSID of the VAP 108C in a BSSID field in a MAC header of one or more management frames (e.g., a beacon frames). Accordingly, for the second MBSSID set, the BSSID of the VAP 108C is referred to as a transmitted BSSID. In some examples, the transmitted BSSID and the MBSSID index may be included in one or more management frames (e.g., beacon frames) transmitted by the AP 102 for the second MBSSID set to the clients associated with the VAPs of the second MBSSID set. The client devices 106C and 106D may deduce a non-transmitted BSSID based on the transmitted BSSID using the MBSSID index contained in such management frames.

Referring again to FIG. 1, in some examples, the first and second MBSSID sets are configured such that each of them addresses one or more QoS parameters. For example, the first MBSSID set may be formed by grouping VAPs (e.g., VAPs 108A and 108B) that address a first QoS (e.g., Low latency). In particular, the VAPs 108A and 108B may be configured to handle the traffic that demands low latency (e.g., video/voice calling) compared to the VAPs 108C and 108D and are grouped to form the first MBSSID set. Accordingly, the client device that associates with the any VAP of the first MBSSID set may have enhanced performance with respect to the first QoS parameter. For the purpose of illustration hereinafter, the first QoS parameter is described as being “Low latency.” Similarly, the second MBSSID set may be formed by grouping VAPs (e.g., VAPs 108C and 108D) that address a second QoS (e.g., High throughput). In particular, the VAPs 108C and 108D may be configured to handle the traffic demanding High throughput compared to the VAPs 108A and 108B and are grouped to form the second MBSSID set. Accordingly, the client devices that associate with the any VAP of the second MBSSID set may have enhanced performance with respect to the second QoS parameter. For the purpose of illustration hereinafter, the second QoS parameter is described as being “High throughput.” Likewise, in some examples, the AP 102 may include more than two MBSSID sets each addressing different QoS parameters.

During the operation of a client device, any change in a communication demand of the client device may negatively impact its performance if the communication demand is not fulfilled by the network. The term “communication demand” as used herein may refer to the communication requirement of the client device that represents the communication behavior of the client device. For example, if the client device 106C sends short data frames/low latency data, the client device 106C may be considered to be demanding low latency. Accordingly, the communication demand for the client device 106C may be determined to be “low latency demand.” Similarly, if the client device 106A requires an overall large amount of data transfer, for example, to stream high-quality video, the client device 106A may be determined as demanding high throughput. Accordingly, the communication demand for the client device 106A may be determined to be “high throughput demand.” As will be apparent, the client devices connected to an AP may not be able to perform with high efficiency if the communication demands of the client devices are not fulfilled by the respective VAPs. This may result in a degraded performance of the client devices and AP which in turn will lead to a poor user experience.

The example AP 102 of the system 100 overcomes such technological challenge by managing the associations of the client devices 106A-106D to ensure that each client device is associated with an appropriate one of the MBSSID sets. In some examples, to manage such dynamic association, the AP 102 may maintain a target QoS-demand mapping 114. The AP 102 may store the target QoS-demand mapping 114 in a machine-readable medium 112. The target QoS-demand mapping 114 may include a mapping between the communication demand and respective target QoS parameter and MBSSID sets. Table-2 presented below depicts example information related to the target QoS-demand mapping 114.

TABLE 2
Example target QoS-demand mapping 114

| Communication Demand | Target QoS Parameter | VAP |
|---|---|---|
| low latency demand | Low latency | First |
| | (i.e., first QoS parameter) | MBSSID set |
| High data rate demand | High throughput | Second |
| | (i.e., second QoS parameter) | MBSSID set |

For illustration purposes, the example target QoS-demand mapping in Table-2 is shown for two types of communication demand and two types of target QoS parameters. In some examples, one or more of the MBSSID sets configured on the AP 102 may address more than one QoS parameter and therefore fulfill respective more than one communication demand. Accordingly, in some examples, the target QoS-demand mapping 114 may include more than two types of communication demands and more than two types of target QoS parameters addressed by the multiple MBSSID sets.

During operation, the AP 102 executes the instructions 104 to manage associations of the client devices 106A-106D with an appropriate MBSSID set resulting in improved performance of the client devices 106A-106D. For example, the processing resource 110 of the AP 102 executes one or more of the instructions 104 to periodically monitor the client devices 106A-106D to determine their communication demands and manage their associations with the VAPs 108A-108D. In the description hereinafter several operations are described with reference to managing the association of the client device 106A for illustration purposes. Likewise, other client devices 106B-106D may also be managed, for example.

The AP 102 monitors (e.g., by way of the processing resource 110 executing one or more of the instructions 104) the data traffic corresponding to the client device 106A. For example, the AP 102 may monitor data frames transmitted by the client device 106A and data frames that are directed to the client device 106A. Based on the monitoring of the data traffic, the AP 102 may determine a communication demand of the client device 106, for example, by way of the processing resource 110 executing one or more of the instructions 104. If the AP 102 determines that there is an MBSSID set that can better cater to the communication demand of the client device 106A, the AP 102 is configured to steer the client device 106A to a VAP of such a relevant MBSSID set (e.g., by way of the processing resource 110 executing one or more of the instructions 104). For example, if the client device 106A is identified to have high throughput demand, the AP 102 may determine that the VAP 108A of the first MBSSID set to which the client device 106A is currently associated is not an appropriate VAP for efficient operation of the client device 106A. Based on the target QoS-demand mapping 114, the AP 102 may determine that the second MBSSID set is relevant to the communication demand of the client device 106A as the VAPs of the second MBSSID set address the QoS parameter “Low latency.”

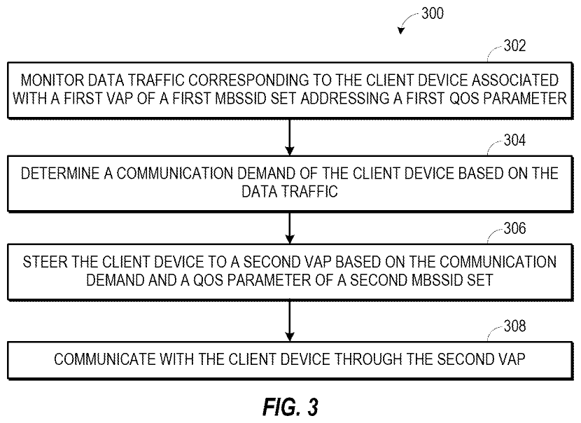

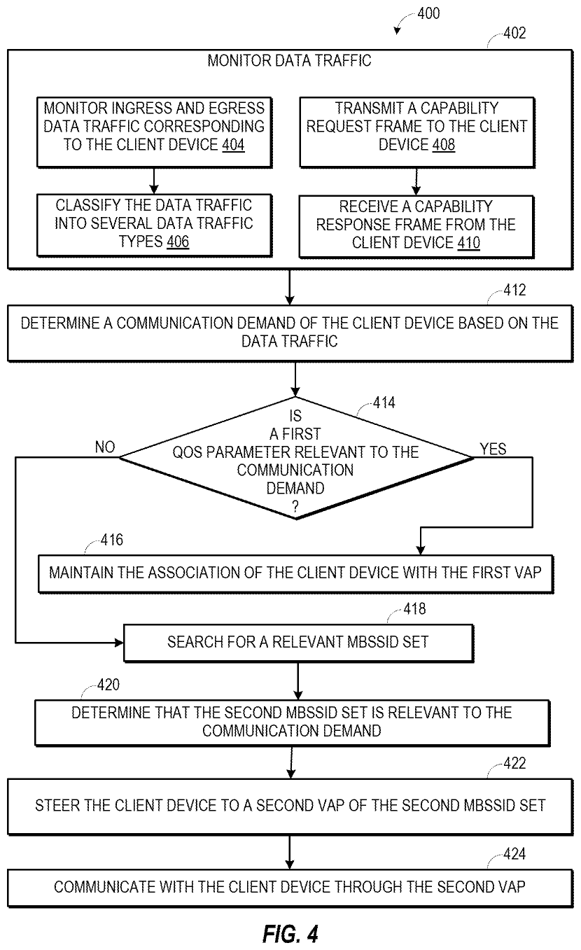

As will be appreciated, the Association of the client device 106A with any of the VAPs of the second MBSSID set may allow the client device 106A to operate more efficiently than its original association with the VAP 108A of the first MBSSID set. In particular, by steering the client device 106A in this manner to an appropriate VAP (e.g., a VAP of the second MBSSID set), the performance of the client device 106A with respect to its communication demand can be improved and both the AP 102 and the client device 106A can benefit from advanced Wi-Fi communication features such as MU transmissions (as will be described later) thereby enhancing overall airtime efficiency. Additional details of managing the association of a client device by the AP 102 are described in conjunction with methods described in FIGS. 3 and 4.

FIG. 3 depicts an example method 300 for managing the association of a client device with VAPs hosted on an AP. The method 300 includes several steps in an order. However, the order of steps shown in FIG. 3 should not be construed as the only order for the steps. The steps may be performed at any time, in any order. Additionally, the steps may be repeated or omitted as needed.

In some examples, the steps shown in FIG. 3 may be performed by any suitable device, such as an AP (e.g., the AP 102 of FIG. 1). In some examples, the suitable device may include a hardware processing resource, such as one or more central processing units (CPUs), semiconductor-based microprocessors, and/or other hardware devices suitable for retrieval and execution of instructions stored in a machine-readable storage medium. The processing resource may fetch, decode, and execute instructions, to manage the association of the client device with VAPs hosted on the AP. As an alternative or in addition to retrieving and executing instructions, the processing resource may include one or more electronic circuits that include electronic components for performing the functionality of one or more instructions, such as an FPGA, ASIC, or other electronic circuits. A machine-readable storage medium may be any electronic, magnetic, optical, or other physical storage device that contains or stores executable instructions. Thus, a machine-readable storage medium may be, for example, a RAM, an NVRAM, an EEPROM, a storage device, an optical disc, and the like. In some embodiments, a machine-readable storage medium may be a non-transitory storage medium, where the term “non-transitory” does not encompass transitory propagating signals. The processing resource and the machine-readable storage medium may be example representatives of the processing resource 110 and the machine-readable storage medium 112 of FIG. 1.

At step 302, the AP monitors (e.g., periodically) data traffic corresponding to the client device (e.g., the client device 106A of FIG. 1) associated with a first VAP (e.g., the VAP 108A of FIG. 1) hosted on the AP. The first VAP is mapped to a first MBSSID set that is configured with a first QoS parameter. In particular, the first MBSSID set may include VAPs that are configured to address the first QoS parameter, for example, low latency. Accordingly, the VAPs forming the first MBSSID set are capable of efficiently handling traffic, such as, voice and/or video calling, that demands low latency. Further, the AP may also host a second VAP (e.g., the VAP 108C of FIG. 1) that is part of a second MBSSID set. In particular, the second MBSSID set may include VAPs that are configured to address a second QoS parameter, for example, high throughput. Accordingly, the VAPs forming the second MBSSID set are capable of efficiently handling large amounts of data traffic, such as, video streaming, file downloads, etc. In particular, at step 302, the AP may monitor both ingress and egress traffic corresponding to the client device at the AP. In one example, monitoring the data traffic of the client device may include applying a predefined classification logic to the data traffic and classifying the data traffic into several data traffic types. For example, the data traffic types may include short data packets, frequent data packets, large packets/high traffic, and the like. Certain additional details regarding the monitoring of the data traffic are described in FIG. 4.

Further, at step 304, the AP determines a communication demand of the client device based on the data traffic corresponding to the client device. As previously noted, the communication demand of the client device represents a communication behavior of the client device and is determined based on the monitored data traffic. In particular, in one example, the AP maintains a mapping between the data traffic types derived based on the monitoring and the communication demands in the form of a lookup table or any other type of data structure establishing such a relationship. The AP may use such a relationship between the data traffic types and the communication demands to determine the communication demand of the client device. For example, if the data traffic corresponding to the client device is identified to include large packets, for example, indicative of video streaming or large file downloads, the AP may determine that the communication demand for the client device is “high throughput.”

Once the communication demand is determined, the AP may determine if the communication demand is relevant to the QoS parameter of the MBSSID of the VAP that the client device is associated with. The AP may refer to a predefined mapping, for example, the target QoS-demand mapping (see Table-2) to determine the relevancy of the communication demand with the QoS parameter of the MBSSID. In the present example, the AP may perform a check to determine if the communication demand (e.g., “high throughput”) of the client device is relevant to the first QoS parameter (e.g., “Low latency”).

The AP, based on the target QoS-demand mapping, may determine that the “high throughput” communication demand of the client device cannot be efficiently fulfilled by its association with the first VAP of the first MBSSID set. Instead, the AP may determine that the “high throughput” communication demand may be better fulfilled if the client device associates with any of the VAPs forming the second MBSSID set. Accordingly, at step 306, the AP may steer the client device to the second VAP based on the communication demand and the second QoS parameter. In particular, based on the target QoS-demand mapping, the AP may determine that the second QoS parameter (e.g., “high throughput”) is relevant to the communication demand of the client device. Accordingly, the AP may steer the client device from the first VAP to the second VAP. The steering of the client device may include dissociating the client device from the first VAP and associating the client device with the second VAP. The second VAP may be any VAP of the second MBSSID set. In some examples, the AP may select the second VAP based on predefined VAP selection criteria without limiting the scope of the present disclosure. For example, such VAP selection criteria may be based on a number of associated clients for a VAP, VAP's performance, etc. Moreover, at step 308, the AP communicates with the client device through the second VAP.

Referring now to FIG. 4, an example method 400 for managing the association of a client device with VAPs hosted on an AP is presented. The method 400 of FIG. 4 is an example representative of the method 300 of FIG. 3. The method 400 includes several steps in an order. However, the order of steps shown in FIG. 4 should not be construed as the only order for the steps. The steps may be performed at any time, in any order. Additionally, the steps may be repeated or omitted as needed. In some examples, the steps shown in FIG. 4 may be performed by any suitable device, such as an AP (e.g., the AP 102 of FIG. 1). In some examples, the suitable device may include a hardware processing resource and/or other hardware devices suitable for retrieval and execution of instructions stored in a machine-readable storage medium. The processing resource and the machine-readable storage medium may be example representatives of the processing resource 110 and the machine-readable storage medium 112 of FIG. 1.

At step 402, the AP monitors data traffic corresponding to the client device (e.g., the client device 106A of FIG. 1) associated with a first VAP (e.g., the VAP 108A of FIG. 1) hosted on the AP. The first VAP is mapped to a first MBSSID set that is configured with a first QoS parameter. Further, the AP may also host a second VAP (e.g., the VAP 108C of FIG. 1) that is part of a second MBSSID set. In particular, in one example, monitoring at step 402, may include monitoring both ingress and egress data traffic corresponding to the client device at the AP at step 404. Further, at step 406, the AP may analyze the data traffic. For example, at step 406, the AP may classify the data traffic into several data traffic types by applying a packet classification logic. For example, the data traffic types may include short data packets, frequent data packets, large packets/high traffic, and the like. In some examples, the AP may periodically monitor data traffic corresponding to the client device.

Alternatively or in addition to steps 404 and 406, in some examples, the AP, at step 408, may transmit a capability request frame to the client device. The capability request frame may be sent to the client device to request the communication capabilities of the client device. In one example, the capability request frame may be an MU trigger frame comprising a transmitted BSSID of the first MBSSID set. The trigger frame may be compliant with the IEEE 802.11ax Specification and is sent to all client devices associated with the first MBSSID set. In particular, any frame exchange sequence that involves HE MU PPDU (High Efficiency Multiple User Physical Layer Protocol Data Unit) or HE TB PPDU (High Efficiency Trigger Based Physical Layer Protocol Data Unit) compliant with the IEEE 802.11 Specifications is optimal when trigger frames are used in addition. For example, in the case of the frame exchange sequence between the AP and the client devices using the HE MU PPDU, the AP may send the trigger frame to the client devices after the transmitting of the Downlink OFDMA (DLOFDMA) or Downlink Multiple User Multiple Input Multiple Output (DLMUMIMO) frame(s). The AP may receive an acknowledgment (Uplink OFDMA-ULOFDMA) frame from the client devices.

In another example, in the case of the frame exchange sequence between the AP and the client devices using the HE TB PPDU, the AP may send the trigger frame to the client devices followed by a ULOFDMA or a ULMUMIMO transmission. The AP may receive a multi-station block acknowledgment for the trigger frame from the client devices after the ULOFDMA or ULMUMIMO transmission. As will be appreciated, by virtue of being in a single MBSSID set, these client devices associated with the VAPs of the first MBSSID set can be addressed by a single trigger frame. Hence the data transmitted by these client devices can now be part of the same MU frames exchange sequences.

At step 410, the AP may receive a capability response frame from the client device. The capability response frame includes the communication capabilities of the client devices, and wherein the communication demand of the client device is determined based on the response frame. For example, in response to a trigger frame such as a Buffer Status Report Poll (BSRP), the client device may send a response frame providing information regarding its load indicative of the quantity and types (e.g., video, voice, etc.) of frames the client device is planning to send. Similarly, in some examples, in response to a trigger frame such as an MU Request to Send (MU-RTS), the client device may send details indicating Clear to Send (CTS).

Further, at block 412, the AP determines a communication demand of the client device based on the data traffic corresponding to the client device. In particular, the AP may determine the communication demand based on one or both of the data traffic types derived based on egress and ingress data traffic monitored at step 404 and the capability response frame received from the client device at step 410. For example, the AP maintains a mapping between the data traffic types derived based on the monitoring and the communication demands in the form of a lookup table or any other type of data structure establishing such a relationship. The AP may use such a relationship between the data traffic types and the communication demands to determine the communication demand of the client device. For example, if the data traffic corresponding to the client device is identified to entail large packets, for example, indicative of video streaming or large file downloads, the AP may determine that the communication demand for the client device is “high throughput.”

Once the communication demand is determined, at step 414, the AP may perform a check to determine if the first QoS parameter is relevant to the communication demand of the client device. A given QoS parameter is said to be relevant to a given communication demand if an MBSSID set configured with VAPs addressing the given QoS parameter is capable of fulfilling the communication demand. As previously noted, the AP maintains a target QoS-demand mapping indicating relevant QoS parameters for several types of communication demands. At step 414, the AP may reference the target QoS-demand mapping to perform the referenced check. At step 414, if it is determined that the first QoS parameter is relevant to the communication demand of the client device, at step 416, the AP may maintain the association of the client device with the first VAP. However, in the ongoing example, the determined communication demand “high throughput” may not be fulfilled by the VAPs of the first MBSSID set as the first MBSSID set is configured with the first QoS parameter that is “Low latency.” Accordingly, the AP may determine that the first QoS parameter is irrelevant to the communication demand of the client device.

At step 414, if it is determined that the first QoS parameter is irrelevant to the communication demand of the client device, the AP, at step 418, may search a plurality of MBSSID sets to find a relevant MBSSID set corresponding to the communication demand of the client device. In particular, at step 418, the AP may reference the target QoS-demand mapping to find the relevant MBSSID set. In particular, in the ongoing example, the AP, may perform a search/look-up in the QoS-demand mapping for the communication demand “high throughput”. In particular, based on the target QoS-demand mapping, the AP, at step 420, may determine that the second QoS parameter (e.g., “high throughput”) is relevant to the communication demand of the client device. Accordingly, at step 420, the AP may determine that the second MBSSID set is relevant to the communication demand as it addresses the high throughput QoS parameter, for example.

Moreover, at step 422, the AP may steer the client device to a second VAP based on the communication demand and the second QoS parameter. The second VAP may be any VAP of the second MBSSID set, for example. The steering of the client device may include dissociating the client device from the first VAP and associating the client device with the second VAP. Furthermore, at step 424, the AP communicates with the client device through the second VAP.

In some examples, the AP may obtain information regarding TWT service period for the client device based on TWT negotiation communications. Accordingly, the AP may communicate the trigger frames during TWT service periods. Accordingly, in some examples, if the AP determines (e.g., based on the monitoring at step 402) that certain client devices have overlapping TWT service periods, the AP may steer such client devices to a common MBSSID set.

Also, in some examples, the AP may obtain information such as channel usage based on monitoring of data traffic such as association responses from the client device. Accordingly, in some examples, the AP may steer the client devices based on identical behavioral properties, such as, the use of a common channel. For example, if two or more 20 MHz-only client devices are part of the same MBSSID set, and operating only in the primary channel, they can support a restricted/limited number of resource utilization (RU) combinations when grouped in an MU PPDU. Hence there is a benefit in spreading them across different MBSSID sets. Accordingly, if the AP determines (e.g., based on the monitoring at step 402) that the client device only uses a single channel (e.g., the client device is enabled with 20 MHz only support) and other client devices are using the same channel in the first MBSSID set, the AP may steer the client device to another MBSSID set.

Moreover, in some examples, the AP may obtain information such as a support for High Efficiency Spatial Multiplexing Power Save (HE SMPS) based on monitoring of data traffic such as association responses from the client device. Generally, MU Request to Send (RTS)/Clear to Send (CTS) frame exchange sequence precedes any uplink or downlink MU frame exchange sequence for client devices that support dynamic HE SMPS. Therefore, it may be an additional overhead for clients that are operating with all the chains active and grouped with HE SMPS clients in a MU transmission. Accordingly, in yet another example, the AP may steer the client devices based on similar traffic conditions. For example, if the AP determines (e.g., based on the monitoring at step 402) that the client device advertises support for dynamic HE SMPS, the AP may steer the client device to a specific MBSSID set that includes other client devices that support HE SMPS.

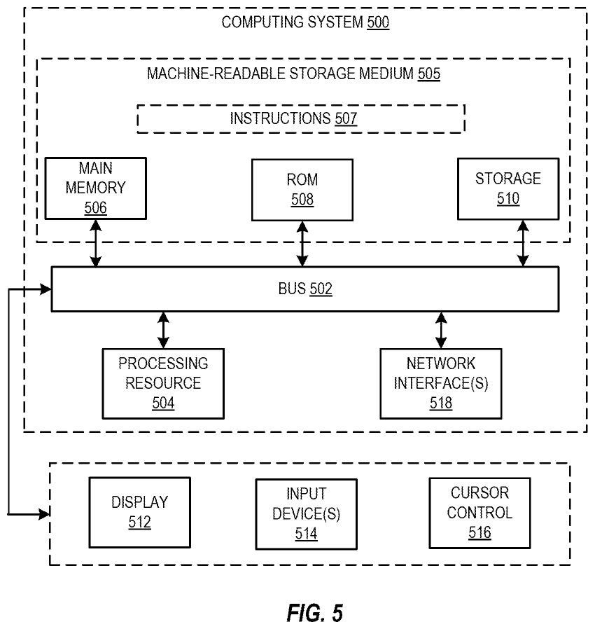

FIG. 5 depicts a block diagram of an example computing system 500 in which various of the examples described herein may be implemented. In some examples, the computing system 500 may be configured to operate as an AP and can perform various operations described in one or more of the earlier drawings.

The computing system 500 may include a bus 502 or other communication mechanisms for communicating information, a hardware processor, also referred to as processing resource 504, and a machine-readable storage medium 505 coupled to the bus 502 for processing information. In some examples, the processing resource 504 may include one or more CPUs, semiconductor-based microprocessors, and/or other hardware devices suitable for retrieval and execution of instructions stored in a machine-readable storage medium 505. The processing resource 504 may fetch, decode, and execute instructions, to manage an association of client devices with VAPs. As an alternative or in addition to retrieving and executing instructions, the processing resource 504 may include one or more electronic circuits that include electronic components for performing the functionality of one or more instructions, such as an FPGA, an ASIC, or other electronic circuits.

In some examples, the machine-readable storage medium 505 may include a main memory 506, such as a RAM, cache and/or other dynamic storage devices, coupled to the bus 502 for storing information and instructions to be executed by the processing resource 504. The main memory 506 may also be used for storing temporary variables or other intermediate information during the execution of instructions to be executed by the processing resource 504. Such instructions, when stored in storage media accessible to the processing resource 504, render the computing system 500 into a special-purpose machine that is customized to perform the operations specified in the instructions. The machine-readable storage medium 505 may further include a read-only memory (ROM) 508 or other static storage device coupled to the bus 502 for storing static information and instructions for the processing resource 504. Further, in the machine-readable storage medium 505, a storage device 510, such as a magnetic disk, optical disk, or USB thumb drive (Flash drive), etc., may be provided and coupled to the bus 502 for storing information and instructions.

Further, in some implementations, the computing system 500 may be coupled, via the bus 502, to a display 512, such as a liquid crystal display (LCD) (or touch-sensitive screen), for displaying information to a computer user. In some examples, an input device 514, including alphanumeric and other keys (physical or software generated and displayed on touch-sensitive screen), may be coupled to the bus 502 for communicating information and command selections to the processing resource 504. Also, in some examples, another type of user input device may be a cursor control 516, such as a mouse, a trackball, or cursor direction keys may be connected to the bus 502. The cursor control 516 may communicate direction information and command selections to the processing resource 504 for controlling cursor movement on the display 512. In some other examples, the same direction information and command selections as cursor control may be implemented via receiving touches on a touch screen without a cursor.

In some examples, the computing system 500 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

The computing system 500 also includes a network interface 518 coupled to bus 502. The network interface 518 provides a two-way data communication coupling to one or more network links that are connected to one or more local networks. For example, the network interface 518 may be an integrated services digital network (ISDN) card, cable modem, satellite modem, or a modem to provide a data communication connection to a corresponding type of telephone line. As another example, the network interface 518 may be a local area network (LAN) card or a wireless communication unit (e.g., Wi-Fi chip/module).

In some examples, the machine-readable storage medium 505 (e.g., one or more of the main memory 506, the ROM 508, or the storage device 510) stores instructions 507 which when executed by the processing resource 504 may cause the processing resource 504 to execute one or more of the methods/operations described hereinabove. The instructions 507 may be stored on any of the main memory 506, the ROM 508, or the storage device 510. In some examples, the instructions 507 may be distributed across one or more of the main memory 506, the ROM 508, or the storage device 510. In some examples, when the computing system 500 is configured to operate as an AP, the instructions 507 may include instructions which when executed by the processing resource 504 may cause the processing resource 504 to perform one or more of the methods described in FIGS. 3 and 4.

Terms and phrases used in this document, and variations thereof, unless otherwise expressly stated, should be construed as open-ended as opposed to limiting. As examples of the foregoing, the term “including” should be read as meaning “including, without limitation” or the like. The term “example” is used to provide exemplary instances of the item in the discussion, not an exhaustive or limiting list thereof. The terms “a” or “an” should be read as meaning “at least one,” “one or more” or the like. The presence of broadening words and phrases such as “one or more,” “at least,” “but not limited to” or other like phrases in some instances shall not be read to mean that the narrower case is intended or required in instances where such broadening phrases may be absent. Further, the term “and/or” as used herein refers to and encompasses any and all possible combinations of the associated listed items. It will also be understood that, although the terms first, second, etc., may be used herein to describe various elements, these elements should not be limited by these terms, as these terms are only used to distinguish one element from another unless stated otherwise or the context indicates otherwise.

What is claimed is:

1. A method comprising:
monitoring, by an access point (AP), data traffic corresponding to a client device associated with a first virtual access point (VAP) hosted on the AP, wherein the first VAP is mapped to a first Multiple Basic Service Set Identifier (MBSSID) set configured with a first quality of service (QoS) parameter, and wherein the AP also hosts a second VAP mapped to a second MBSSID set configured with a second QoS parameter;
determining, by the AP, a communication demand of the client device based on the data traffic corresponding to the client device;
steering, by the AP, the client device to the second VAP based on the communication demand and the second QoS parameter; and
communicating, by the AP, with the client device through the second VAP.

2. The method of claim 1, wherein monitoring the data traffic comprises:
classifying the data traffic into a plurality of data traffic types corresponding to the client device; and
determining the communication demand based on the plurality of data traffic types.

3. The method of claim 1, wherein monitoring the data traffic comprises:
transmitting, by the AP, a capability request frame to the client device; and
receiving, by the AP, a capability response frame from the client device, wherein the capability response frame comprises communication capabilities of the client devices, and wherein the communication demand of the client device is determined based on the response frame.

4. The method of claim 3, wherein the capability request frame is a multiple user (MU) trigger frame comprising a transmitted BSSID of the first MBSSID set, and wherein the trigger frame is sent to all client devices associated with the first MBSSID set.

5. The method of claim 1, wherein the first VAP and the second VAP are configured on a same radio of the AP.

6. The method of claim 1, wherein the first VAP and the second VAP are configured on different radios of the AP.

7. The method of claim 1, further comprising maintaining, by the AP, association of the client device with the first VAP in response to determining that the first QoS parameter is relevant to the communication demand of the client device.

8. The method of claim 1, further comprising:
searching, by the AP, a plurality of MBSSID sets to find a relevant MBSSID set corresponding to the communication demand of the client device in response to determining that the first QoS parameter is irrelevant to the communication demand of the client device; and
determining, by the AP, that the second MBSSID set is the relevant MBSSID set corresponding to the communication demand of the client device based on the searching.

9. The method of claim 1, wherein the communication of the AP with the client device via the second VAP enhances a performance of the client device as the communication demand of the client is fulfilled by the second MBSSID set configured to address the second QoS parameter.

10. An AP, comprising:
a machine-readable storage medium storing executable instructions; and
a processing resource coupled to the machine-readable storage medium, wherein the processing resource executes one or more of the executable instructions to:
monitor data traffic corresponding to a client device associated with a first VAP hosted on the AP, wherein the first VAP is mapped to a first MBSSID set configured with a first QoS parameter, and wherein the AP also hosts a second VAP mapped to a second MBSSID set configured with a second QoS parameter;
determine a communication demand of the client device based on the data traffic corresponding to the client device;
steer the client device to the second VAP based on the communication demand and the second QoS parameter; and
communicate with the client device through the second VAP.

11. The AP of claim 10, wherein the data traffic is monitored periodically.

12. The AP of claim 10, wherein the processing resource executes one or more of the instructions to:
transmit a capability request frame to the client device;
receive a capability response frame from the client device, wherein the capability response frame comprises communication capabilities of the client devices; and
determine the communication demand based on the response frame.

13. The AP of claim 12, wherein the capability request frame is a multiple user (MU) trigger frame comprising a transmitted BSSID of the first MBSSID set, and wherein the trigger frame is sent to all client devices associated with the first MBSSID set.

14. The AP of claim 10, wherein the first VAP is configured on any of a 2.4 GHz radio, 5 GHz radio, or a 6 GHz radio.

15. The AP of claim 10, wherein the second VAP is configured on any of a 2.4 GHz radio, 5 GHz radio, or a 6 GHz radio.

16. The AP of claim 10, wherein the processing resource executes one or more of the instructions to maintain an association of the client device with the first VAP in response to determining that the first QoS parameter is relevant to the communication demand of the client device.

17. The AP of claim 10, wherein the processing resource executes one or more of the instructions to:
search a plurality of MBSSID sets to find a relevant MBSSID set corresponding to the communication demand of the client device in response to determining that the first QoS parameter is irrelevant to the communication demand of the client device; and
determine that the second MBSSID set is the relevant MBSSID set corresponding to the communication demand of the client device based on the search.

18. A system, comprising:
a client device; and
an AP communicatively coupled to the client device, wherein the AP hosts a first VAP and a second VAP, wherein the first VAP is mapped to a first MBSSID set configured with a first QoS parameter and the second VAP is mapped to a second MBSSID set configured with a second QoS parameter, wherein the client device is associated with the first VAP, and wherein the AP is configured to:
monitor data traffic corresponding to the client device;
determine a communication demand of the client device based on the data traffic corresponding to the client device;
steer the client device to the second VAP based on the communication demand and the second QoS parameter; and
communicate with the client device through the second VAP.

19. The system of claim 18, wherein the AP is configured to maintain an association of the client device with the first VAP in response to determining that the first QoS parameter is relevant to the communication demand of the client device.

20. The system of claim 18, wherein the AP is configured to:
search a plurality of MBSSID sets to find a relevant MBSSID set corresponding to the communication demand of the client device in response to determining that the first QoS parameter is irrelevant to the communication demand of the client device; and
determine that the second MBSSID set is the relevant MBSSID set corresponding to the communication demand of the client device based on the search.
